(19) United States
(12) Patent Application Publication
(10) Pub. No.: US 2022/0043153 A1
(43) Pub. Date: Feb. 10, 2022

(54) Light Detection and Ranging

(71) Applicant: Envisics Ltd, Milton Keynes (GB)

(72) Inventors: Timothy Smeeton, Milton Keynes (GB); Konstantinos Papadimitriou, Milton Keynes (GB)

(73) Assignee: Envisics Ltd, Milton Keynes (GB)

(21) Appl. No.: 17/363,089

(22) Filed: Jun. 30, 2021

(30) Foreign Application Priority Data
Aug. 5, 2020 (GB) GB 2012147.1

(51) Int. Cl. G01S 17/89; G03H 1/00; G01S 17/10

(52) U.S. Cl. CPC G01S 17/89; G03H 2001/0033; G01S 17/10; G03H 1/0005

(57) ABSTRACT

There is disclosed herein a method of light detection and ranging. The method comprises a first step of illuminating a scene with a first light pattern and monitoring for first light return from the scene with an array of detection elements. The method comprises a second step of obtaining first point cloud data from first parts of the scene where the first light return exceeds a first threshold value. The method comprises a third step of determining a second light pattern by reducing, such as substantially zeroing, the intensity of the first light pattern in the areas wherein first point cloud data was obtained. The method comprises a fourth step of illuminating the scene with the second light pattern and monitoring for second light return from the scene with the array of detection elements.

### CROSS-REFERENCE TO RELATED APPLICATIONS

This application claims priority under 35 U.S.C. § 119 to UK Patent Application GB 2012147.1, titled “Light Detection and Ranging,” filed on Aug. 5, 2020. The entire contents of GB 2012147.1 are incorporated by reference herein for all purposes.

### FIELD

The present disclosure relates to a holographic projector for projecting light patterns. The present disclosure also relates to light detection and ranging, “LIDAR”. Some embodiments relate to a method of recursive scanning for LIDAR. Other embodiments relate to a LIDAR system comprising a holographic projector of light patterns and a detector array.

### BACKGROUND AND INTRODUCTION

Light scattered from an object contains both amplitude and phase information. This amplitude and phase information can be captured on a photosensitive plate or film using an interference technique called holography. The pattern captured on the photosensitive plate or film is referred to as a holographic recording or hologram. The hologram may be used to form a reconstruction of the object. The reconstruction of the object formed by the hologram is referred to as a holographic reconstruction. The holographic reconstruction may be formed by illuminating the hologram with suitable light.

Computer-generated holography may numerically simulate the processes used to form a hologram by interference of light. A computer-generated hologram may be calculated using a mathematical transformation. The mathematical transform may be based on a Fourier transform. The mathematical transform may be a Fourier transform or Fresnel transform. A hologram calculated by performing a Fourier transform of a target image may be referred to as a Fourier transform hologram or Fourier hologram. A Fourier hologram may be considered a Fourier domain, or frequency domain, representation of the target image. A hologram calculated using a Fresnel transform may be referred to as a Fresnel hologram.

A computer-generated hologram may comprise an array of hologram values which may be referred to as hologram pixels. Each hologram value may be a phase and/or amplitude value. Each hologram value may be constrained—e.g. quantised—to one of a plurality of allowable values. A computer-generated hologram may be displayed on a display device. The choice of allowable values may be based on the display device which will be used to display the hologram. The plurality of allowable values may be based on the capabilities of the display device.

The display device may be a spatial light modulator comprising an array of pixels. The spatial light modulator may be a liquid crystal device in which case each pixel is an individually-addressable liquid crystal cell having birefringence. Each pixel may modulate the amplitude and/or phase of light in accordance with a corresponding hologram pixel. Each pixel comprises a light-modulating element and a pixel circuit arranged to drive the light-modulating element. The hologram may be considered a light modulation pattern.

A holographic reconstruction may be formed by illuminating the displayed hologram with suitable light. The amplitude and/or phase of incident light is spatially modulated in accordance with the light modulation pattern. The light is diffracted by the spatial light modulator. The complex light pattern emanating from the display device interferes at a replay plane to form a holographic reconstruction corresponding to the target image. If the hologram is a Fourier hologram, the replay plane is in the far-field (i.e. an infinite distance from the display device) but a lens may be used to bring the replay plane into the near-field. For convenience, the holographic reconstruction itself may be referred to as an image. The holographic reconstruction is projected onto a plane away from the display device and the technique is therefore known as holographic projection. The image projected in accordance with this disclosure is referred to as a light pattern.

A light detection and ranging system may be formed using a holographic projector to project dynamically-reconfigured light patterns onto objects in a scene. There is disclosed herein a method of optimising the holographic light pattern for light detection and ranging using an array detector.

### SUMMARY

There is disclosed herein a method of light detection and ranging. The method comprises a first step of illuminating a scene with a first light pattern and monitoring for first light return from the scene with an array of detection elements. The method comprises a second step of obtaining first point cloud data from first parts of the scene where the first light return exceeds a first threshold value. The method comprises a third step of determining a second light pattern by reducing—such as substantially zeroing—the intensity of the first light pattern in the areas wherein first point cloud data was obtained. The method comprises a fourth step of illuminating the scene with the second light pattern and monitoring for second light return from the scene with the array of detection elements.

A feature of holographic projection is that the intensity of the image formed on the holographic replay plane by the hologram is a function of the amount of image content. This is because the hologram is a diffractive pattern that redistributes light. The more areas of the replay plane that receive light, the lower the brightness of each area receiving light. In other words, the number of image pixels of the holographic replay field that are switched “on” (i.e. receive light from the hologram) determines the brightness of each “on” image pixel. For example, the brightness of each image spot of a hologram forming two image spots is greater than the brightness of each image spot of a hologram forming three image spots. This is not true in conventional display in which an image, not a hologram of an image, is displayed on the display device.

The applicant has previously disclosed a light detection and ranging, “LIDAR”, system using a holographic projector as the light source. The holographic projector may be configured to project an array of light spots into the scene in order to obtain an array of time-of-flight measurements using a detector array comprising a plurality of individual light detecting elements. There may or may not be one-to-one correlation between the holographically-formed light spots and the individual light detecting elements.

There is disclosed herein a method of light detection and ranging using a recursive approach to build up a map of a scene slice by slice. Key to the approach is reducing the amount of image content with each plane in order to increase range. This approach is unique to holography and cannot be derived from a conventional display or LIDAR system in which a change in the amount of image content in the illumination pattern does not change the brightness of each element of the image content. There are disclosed herein a number of particular embodiments that provided an improved holographic LIDAR system based on these core concepts.

By generating recursive holograms, where the next reconstructed hologram light pattern does not illuminate the trajectories that the previous one or more reconstructed hologram light patterns have already illuminated and have obtained point cloud data from, results in more power efficient illumination that every time focus on trajectories of the scene that have not yet yielded point cloud data, rather than illuminating the same trajectories of the scene over and over again.

In an embodiment, the method further comprises obtaining second point cloud data from second parts of the scene wherein the second light return exceeds a second threshold value.

Accordingly, a first light pattern is used to obtain point cloud data from a first volume of space in the scene and a second light pattern is used to obtain point cloud data at a second time from a second volume of space in the scene. The second volume of space may be immediately adjacent to the first volume of space. The first volume of space may comprise a volume of space within 1 metre of the LIDAR device and the second volume of space may comprise a volume of space 1-2 metres from the LIDAR device. Accordingly, a picture of the first 2 metres of the scene may be build up by combining two sets of time of flight measurements in a recursive scheme.

In an embodiment, the number of recursive scans of the scene in accordance with this disclosure is less than five such as two. For example, a first scan may cover up to 20 metres and a second scan may cover up to 100 metres.

In an embodiment, the method further comprises determining an nth light pattern by reducing—such as substantially zeroing—the intensity of the (nth−1) light pattern in the areas wherein (nth−1) point cloud data was obtained and Illuminating the scene with the nth light pattern and monitoring for nth light return from the scene with the array of detection elements.

Each point cloud obtained by the array of detection elements may correspond to a different depth volume in the scene, wherein the distance from the array of detection elements to the depth volume in the scene increases with each successive light pattern.

The method may be extended to any number of adjacent volumes of space in the scene in order to build up a map of the scene. The illumination distribution of each successive light pattern is based on the results in relation to the previous light pattern.

In an embodiment, the total intensity of the light pattern is at least maintained with each successive light pattern. In some embodiments, this comprises increasing the intensity of the light source with each successive light pattern. In other embodiments, this is achieved by forming each light pattern using a respective computer-generated hologram. That is, in an embodiment, each light pattern is formed by illuminating a hologram corresponding to the respective light pattern.

In some embodiments, the method comprises building up an image of a scene volume slice by volume slice starting with the closest volume slice containing the closest objects. The closest objects represent the most immediate danger and are therefore detected first. In accordance with this feature, the range of the LIDAR system inherently increases with each display event. This method step exploits the synergy between holography and LIDAR that does not exist with other light projection techniques.

In an embodiment, the method further comprises calculating of a hologram of each light pattern.

A real-time hologram engine is used to calculate a hologram of each light pattern based on the result of the previous scan. The hologram may be a Fourier or Fresnel hologram calculated using a method based on the Gerchberg-Saxton algorithm.

In an embodiment, each light pattern comprises a plurality of discrete or individual light spots. In an embodiment, the first light pattern comprises a regular array of light spots—e.g. a 2D array of light spots filling the holographic replay field. In some embodiments, the second to nth light patterns comprise a successive smaller subset of the light spots of the first light pattern.

In these embodiments, the sensitivity of the system is increased because each hologram concentrates the light into only a plurality of light spots on the scene. In the case of the spot pattern, the term “uniform” refers to the regular nature of the array and the uniform brightness of the light regions—i.e. the light spots themselves.

In embodiments, the light used to illuminate the scene (that is, the light of each light pattern) is pulsed or gated. The method may further comprise changing the pulse repetition rate at least once such as reducing the pulse repetition rate with each successive light pattern. That is, a first light pattern may be formed using light having a first repetition rate and a second light pattern may be formed using light having a second repetition rate. The pulse repetition rate may be changed at least once during the plurality of illumination-detection events. For example, the pulse repetition rate may be changed every mth light pattern such as every other light pattern. That is, the same repetition rate may be used more than once, or only once.

In these embodiments, the pulse repetition rate is increased to address the problem of “wrap-around” in which a light return signal is associated with the incorrect start time for a time of flight measurement. This can happen when the illumination events are too close together in time for the depth range of interest. The reader will understand that it is crucial to any time of flight measurement system that the start (light emission) and end events (light return signal) are properly paired. The problem of wrap-around can occur if the wrong start event and end event are paired. In accordance with the recursive scheme disclosed herein, the depth range of the system increases with each complete scan. The optical power of each light spot increases with each successive light pattern because the system is holographic and, in some embodiments, the method further comprises decreasing the pulse repetition rate in synchronisation with the increase in optical power to reflect the factor that the range is increasing each time the next light pattern is projected.

The method may further comprise gating the detection window of the array of detection elements and increasing a time delay between illumination and the start of each gate with each successive light pattern.

In a notable further improvement, time gate or window is associated with each successive scan and light return signals falling outside the time window are ignored. The inventors recognised that because a depth (or range of depths) is associated with each scan, each scan has a maximum time of flight and a minimum time of flight. Other values, which usually add noise, can therefore be discarded.

A variation of the repetition frequency, generates a range-gated Holographic LiDAR, where the field of view in front of the device is segmented with respect to depth into the scene. Range-gating “windows” the photons of interest for each range. This can be a useful method to tackle interferences from other LiDAR devices, without the need for optical encoding. In an optional further improvement, the variation in repetition frequency is accompanied by an inverted variation in the peak power of the light pattern (e.g. peak power of the light source illuminating the hologram). This enables optimised light pattern power for each range. Furthermore, the peak power may be used to some extent to limit the maximum range.

Range-gating relies on the fact that the optical peak power is tailored in such as way so that the vast majority of photons will come from the range defined by the repetition frequency of the laser pulses.

There is provided a light detection and ranging system comprising a projector, an array of detection elements and a controller. The projector is arranged to illuminate a scene with a first light pattern and then a second light pattern. The array of detection elements is arranged to monitor for light return in association with the first light pattern and light return in association with the second light pattern. The controller is arranged to obtain first point cloud data from first parts of the scene where first light return corresponding to a first light pattern exceeds a first threshold value and determine the second light pattern by reducing—e.g. substantially zeroing—the intensity of the first light pattern in the areas wherein first point cloud data was obtained.

The projector may be a holographic projector comprising a spatial light modulator arranged to display a first hologram of the first light pattern and then a second hologram of the second light pattern. The projector may be arranged to calculate holograms in real-time.

The first light pattern may comprise a regular array of light spots and, optionally, the second light pattern may comprise a subset of the light spots of the regular array of light spots of the first light pattern.

The first light pattern may be formed using light having a first pulse repetition rate and the second light pattern may be formed using light having a second pulse repetition rate. The second pulse repetition rate may be less than the first pulse repetition rate.

The array of detection elements may have a detection window and the controller may be arranged to increase the time between illumination and start of each detection window with each successive light pattern.

The present disclosure refers to forming a map or picture of a scene by combining a plurality of individual “scans” of the scene. The term “scan” refers to the process of obtaining a time-of-flight measurement in association with each point of a plurality of discrete points on the scene. The plurality of points of each scan define a light pattern. In other words, a light pattern comprising light spots is associated with each scan. The results of each “scan” may be depicted on a plane but each scan relates to a range of depths within the scene (e.g. z=1 to 2 metres), not just one depth (e.g. z=2 metres) as may be suggested by objects depicted on a plane. Each scan therefore has associated with it a volume of space within the scene in which an object may be detected. A range of distance is therefore associated with each scan and each light pattern. The word “plane” or “depth plane” may be used herein as shorthand to refer to the volume slice of the scene (e.g. z=1 to 2 metres) associated with that plane or depth plane. Each scan may itself be made up of a plurality of display-detect events, wherein each display-detect event comprises forming the corresponding light pattern in the scene and detecting any light return. The term “scan” includes building up point cloud data from the scene one zone at a time, wherein a zone is an x-y sub-area of the scene.

The term “light return” is used herein the refer to any light of the light pattern that is reflected back to at least one detection element of the array of detection elements by an object in the scene. In other words, it refers to any light corresponding to the respective light pattern that is reflected by or off an object in the scene and detectable by a detector element of the array of detection elements. The reader will understand that each detector element provides an electrical output based on the amount of light received (e.g. number of photons). That output may be termed a “light return signal” such that it may be said that each “light return” generates a “light return signal”. The reader will also understand that each light return signal (e.g. the amplitude of each light return signal) may be individually compared with a threshold signal value and/or used to make a time-of-flight measurement.

The term “point cloud data” is used herein to refer to the 2D array of data obtained from the corresponding array of detection elements in relation to each scan. The 2D array of data may be used to form a 2D array of time-of-flight measurements from each scan, wherein each position in the 2D array corresponds to a trajectory (e.g. an inclination angle θy and azimuthal angle θx from a reference direction) and the time-of-flight for said trajectory. Each point of the point cloud corresponds to a possible illumination trajectory (e.g. spot) in the scene. It will be understood that some possible illumination trajectories may be not be illuminated (i.e. may be dark) in accordance with the recursive process disclosed herein.

The process disclosed herein may comprise only processing valid data points where the time-of-flight falls within a defined time window measured relative to the time of the start of an emitted pulse of light in the light pattern. In this respect, it will be understood that the detector array has a detection window that is a time window or gate within which e.g. photons are counted. That is, any photons received outside of the time gate are ignored—i.e. they are not counted and/or are not used in any time-of-flight measurements. In some embodiments, each scan has an associated detection window where the range of times within the detection window correspond to the time-of-flight for photons reflected from objects within the volume of space associated with the scan.

In some examples, the spatial light modulator applies phase-only modulation to the light received. The spatial light modulator may thus be a phase-only spatial light modulator. This may be advantageous because no optical energy is lost by modulating amplitude. Accordingly, an efficient holographic projection system is provided. However, the present disclosure may equally be implemented on an amplitude-only spatial light modulator or an amplitude and phase (complex) spatial light modulator. It may be understood that the hologram will be correspondingly phase-only, amplitude-only or fully-complex.

The term “hologram” is used to refer to the recording which contains amplitude and/or phase information about the object. In this disclosure, the input, or received, hologram is a hologram. The entirety of the output, computer-generated, hologram is also a hologram—the term “hologram” encompasses the combination of a full-tile of the input hologram and additional part-tiles. The term “holographic reconstruction” is used to refer to the optical reconstruction of the object which is formed by illuminating the hologram. The term “replay plane” is used to refer to the plane in space where the holographic reconstruction is formed. The terms “image”, “image region” and “replay field” refer to areas of the replay plane illuminated by light forming the holographic reconstruction. In some embodiments, the “image” comprises image spots which may be referred to as “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” or “represent” a light modulation distribution or pattern in response to receiving the plurality of control values.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

The term “light” is used herein in its broadest sense. Some embodiments are equally applicable to visible light, infrared light and ultraviolet light, and any combination thereof.

The present disclosure refers to or describes 1D and 2D holographic reconstructions by way of example only. The holographic reconstruction may alternatively be a 3D holographic reconstruction. That is, in some examples of the present disclosure, each computer-generated hologram forms a 3D holographic reconstruction.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2A illustrates a first iteration of an example Gerchberg-Saxton type algorithm;

FIG. 2B illustrates the second and subsequent iterations of the example Gerchberg-Saxton type algorithm;

FIG. 2C illustrates alternative second and subsequent iterations of the example;

FIG. 3 is a schematic of a reflective LCOS SLM;

FIG. 4 illustrates a scene and corresponding LIDAR map in accordance with the present disclosure;

FIGS. 5A and 5B illustrates the recursive method of the present disclosure;

FIG. 6 illustrate an embodiment of the recursive method using a spot array;

FIG. 7 shows modulation of light pattern peak power and pulse repetition rate; and

FIG. 8 shows detector gating in accordance with some embodiments.

The same reference numbers will be used throughout the drawings to refer to the same or like parts.

### DETAILED DESCRIPTION

The present invention is not restricted to the embodiments described in the following but extends to the full scope of the appended claims. That is, the present invention may be embodied in different forms and should not be construed as limited to the described embodiments, which are set out for the purpose of illustration.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in a co-dependent relationship.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### Optical Configuration

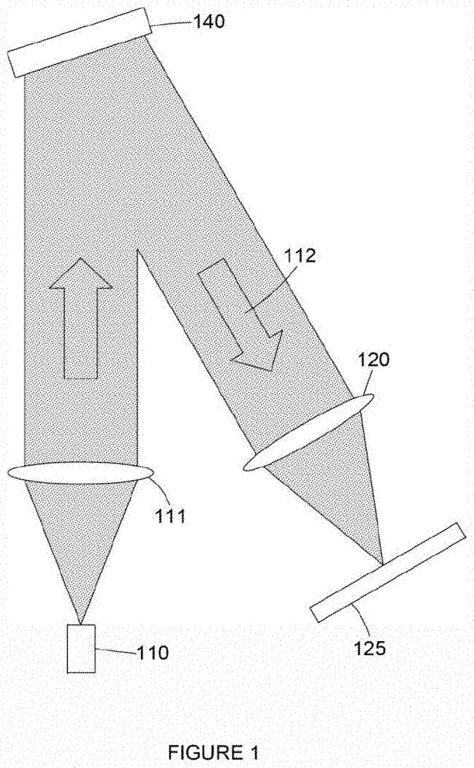

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms.

A Fourier transform hologram may be calculated using an algorithm such as the Gerchberg-Saxton algorithm. Furthermore, the Gerchberg-Saxton algorithm may be used to calculate a hologram in the Fourier domain (i.e. a Fourier transform hologram) from amplitude-only information in the spatial domain (such as a photograph). The phase information related to the object is effectively “retrieved” from the amplitude-only information in the spatial domain. In some embodiments, a computer-generated hologram is calculated from amplitude-only information using the Gerchberg-Saxton algorithm or a variation thereof.

The Gerchberg Saxton algorithm considers the situation when intensity cross-sections of a light beam, l_{A}(x, y) and l_{B}(x, y), in the planes A and B respectively, are known and l_{A}(x, y) and l_{B}(x, y) are related by a single Fourier transform. With the given intensity cross-sections, an approximation to the phase distribution in the planes A and B, ψ_{A}(x, y) and ψ_{B}(x, y) respectively, is found. The Gerchberg-Saxton algorithm finds solutions to this problem by following an iterative process. More specifically, the Gerchberg-Saxton algorithm iteratively applies spatial and spectral constraints while repeatedly transferring a data set (amplitude and phase), representative of lA(x, y) and lB(x, y), between the spatial domain and the Fourier (spectral or frequency) domain. The corresponding computer-generated hologram in the spectral domain is obtained through at least one iteration of the algorithm. The algorithm is convergent and arranged to produce a hologram representing an input image. The hologram may be an amplitude-only hologram, a phase-only hologram or a fully complex hologram.

In some embodiments, a phase-only hologram is calculated using an algorithm based on the Gerchberg-Saxton algorithm such as described in British patent 2,498,170 or 2,501,112 which are hereby incorporated in their entirety by reference. However, embodiments disclosed herein describe calculating a phase-only hologram by way of example only. In these embodiments, the Gerchberg-Saxton algorithm retrieves the phase information ψ[u, v] of the Fourier transform of the data set which gives rise to a known amplitude information T[x, y], wherein the amplitude information T[x, y] is representative of a target image (e.g. a photograph). Since the magnitude and phase are intrinsically combined in the Fourier transform, the transformed magnitude and phase contain useful information about the accuracy of the calculated data set. Thus, the algorithm may be used iteratively with feedback on both the amplitude and the phase information. However, in these embodiments, only the phase information ψ[u, v] is used as the hologram to form a holographic representative of the target image at an image plane. The hologram is a data set (e.g. 2D array) of phase values.

In other embodiments, an algorithm based on the Gerchberg-Saxton algorithm is used to calculate a fully-complex hologram. A fully-complex hologram is a hologram having a magnitude component and a phase component. The hologram is a data set (e.g. 2D array) comprising an array of complex data values wherein each complex data value comprises a magnitude component and a phase component.

In some embodiments, the algorithm processes complex data and the Fourier transforms are complex Fourier transforms. Complex data may be considered as comprising (i) a real component and an imaginary component or (ii) a magnitude component and a phase component. In some embodiments, the two components of the complex data are processed differently at various stages of the algorithm.

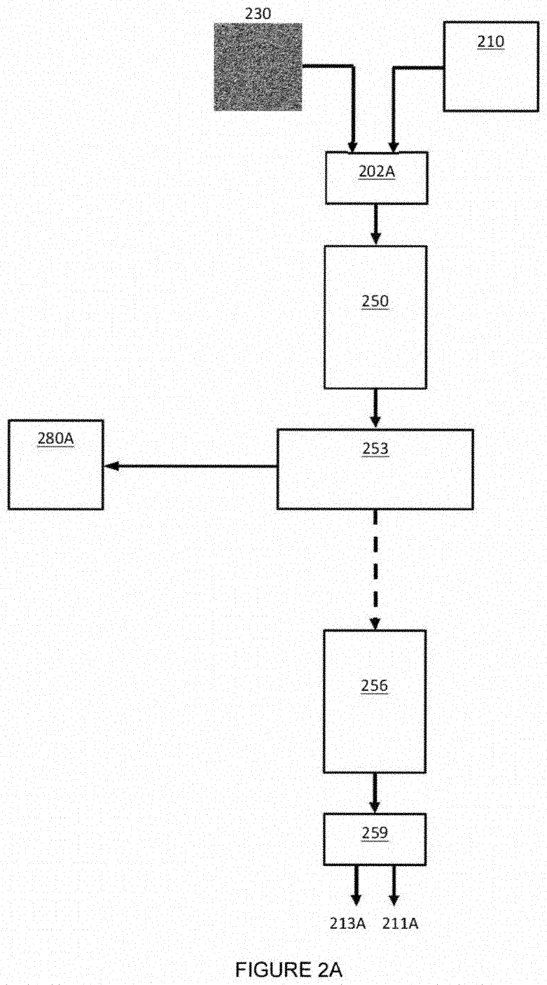

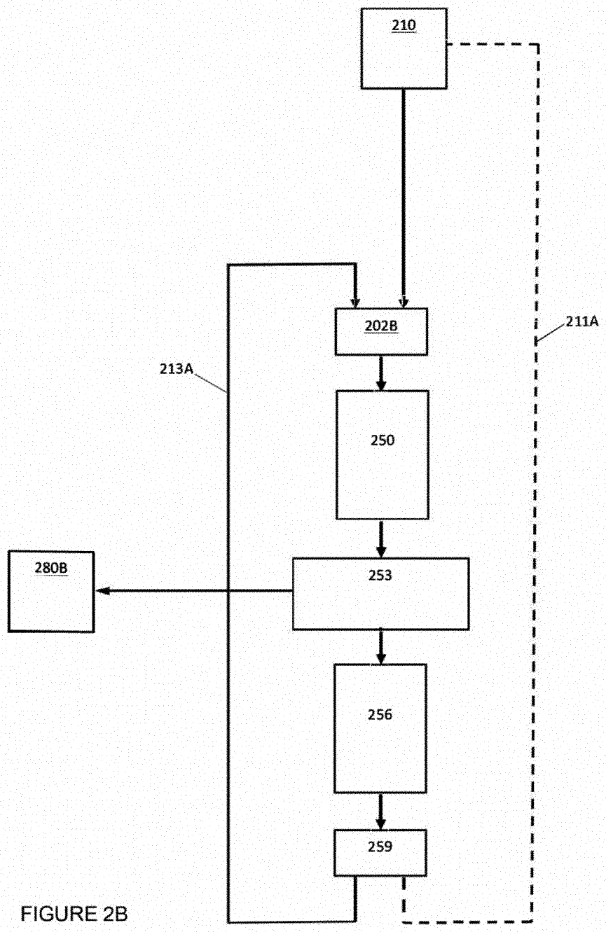

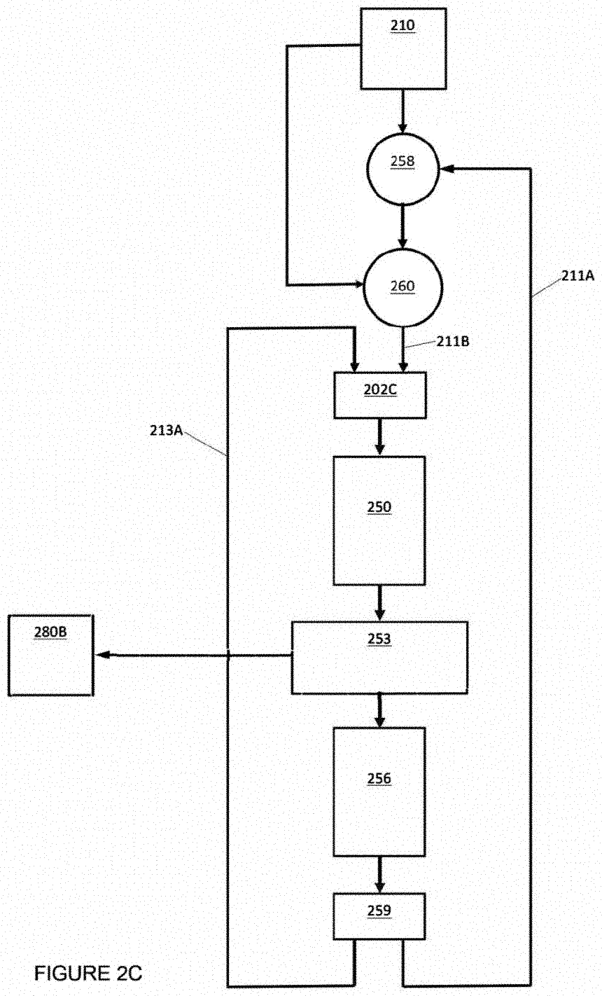

FIG. 2A illustrates the first iteration of an algorithm in accordance with some embodiments for calculating a phase-only hologram. The input to the algorithm is an input image 210 comprising a 2D array of pixels or data values, wherein each pixel or data value is a magnitude, or amplitude, value. That is, each pixel or data value of the input image 210 does not have a phase component. The input image 210 may therefore be considered a magnitude-only or amplitude-only or intensity-only distribution. An example of such an input image 210 is a photograph or one frame of video comprising a temporal sequence of frames. The first iteration of the algorithm starts with a data forming step 202A comprising assigning a random phase value to each pixel of the input image, using a random phase distribution (or random phase seed) 230, to form a starting complex data set wherein each data element of the set comprising magnitude and phase. It may be said that the starting complex data set is representative of the input image in the spatial domain.

First processing block 250 receives the starting complex data set and performs a complex Fourier transform to form a Fourier transformed complex data set. Second processing block 253 receives the Fourier transformed complex data set and outputs a hologram 280A. In some embodiments, the hologram 280A is a phase-only hologram. In these embodiments, second processing block 253 quantises each phase value and sets each amplitude value to unity in order to form hologram 280A. Each phase value is quantised in accordance with the phase-levels which may be represented on the pixels of the spatial light modulator which will be used to “display” the phase-only hologram. For example, if each pixel of the spatial light modulator provides 256 different phase levels, each phase value of the hologram is quantised into one phase level of the 256 possible phase levels. Hologram 280A is a phase-only Fourier hologram which is representative of an input image. In other embodiments, the hologram 280A is a fully complex hologram comprising an array of complex data values (each including an amplitude component and a phase component) derived from the received Fourier transformed complex data set. In some embodiments, second processing block 253 constrains each complex data value to one of a plurality of allowable complex modulation levels to form hologram 280A. The step of constraining may include setting each complex data value to the nearest allowable complex modulation level in the complex plane. It may be said that hologram 280A is representative of the input image in the spectral or Fourier or frequency domain. In some embodiments, the algorithm stops at this point.

However, in other embodiments, the algorithm continues as represented by the dotted arrow in FIG. 2A. In other words, the steps which follow the dotted arrow in FIG. 2A are optional (i.e. not essential to all embodiments).

Third processing block 256 receives the modified complex data set from the second processing block 253 and performs an inverse Fourier transform to form an inverse Fourier transformed complex data set. It may be said that the inverse Fourier transformed complex data set is representative of the input image in the spatial domain.

Fourth processing block 259 receives the inverse Fourier transformed complex data set and extracts the distribution of magnitude values 211A and the distribution of phase values 213A. Optionally, the fourth processing block 259 assesses the distribution of magnitude values 211A. Specifically, the fourth processing block 259 may compare the distribution of magnitude values 211A of the inverse Fourier transformed complex data set with the input image 510 which is itself, of course, a distribution of magnitude values. If the difference between the distribution of magnitude values 211A and the input image 210 is sufficiently small, the fourth processing block 259 may determine that the hologram 280A is acceptable. That is, if the difference between the distribution of magnitude values 211A and the input image 210 is sufficiently small, the fourth processing block 259 may determine that the hologram 280A is a sufficiently-accurate representative of the input image 210. In some embodiments, the distribution of phase values 213A of the inverse Fourier transformed complex data set is ignored for the purpose of the comparison. It will be appreciated that any number of different methods for comparing the distribution of magnitude values 211A and the input image 210 may be employed and the present disclosure is not limited to any particular method. In some embodiments, a mean square difference is calculated and if the mean square difference is less than a threshold value, the hologram 280A is deemed acceptable. If the fourth processing block 259 determines that the hologram 280A is not acceptable, a further iteration of the algorithm may be performed. However, this comparison step is not essential and in other embodiments, the number of iterations of the algorithm performed is predetermined or preset or user-defined.

FIG. 2B represents a second iteration of the algorithm and any further iterations of the algorithm. The distribution of phase values 213A of the preceding iteration is fed-back through the processing blocks of the algorithm. The distribution of magnitude values 211A is rejected in favour of the distribution of magnitude values of the input image 210. In the first iteration, the data forming step 202A formed the first complex data set by combining distribution of magnitude values of the input image 210 with a random phase distribution 230. However, in the second and subsequent iterations, the data forming step 202B comprises forming a complex data set by combining (i) the distribution of phase values 213A from the previous iteration of the algorithm with (ii) the distribution of magnitude values of the input image 210.

The complex data set formed by the data forming step 202B of FIG. 2B is then processed in the same way described with reference to FIG. 2A to form second iteration hologram 280B. The explanation of the process is not therefore repeated here. The algorithm may stop when the second iteration hologram 280B has been calculated. However, any number of further iterations of the algorithm may be performed. It will be understood that the third processing block 256 is only required if the fourth processing block 259 is required or a further iteration is required. The output hologram 280B generally gets better with each iteration. However, in practice, a point is usually reached at which no measurable improvement is observed or the positive benefit of performing a further iteration is out-weighted by the negative effect of additional processing time. Hence, the algorithm is described as iterative and convergent.

FIG. 2C represents an alternative embodiment of the second and subsequent iterations. The distribution of phase values 213A of the preceding iteration is fed-back through the processing blocks of the algorithm. The distribution of magnitude values 211A is rejected in favour of an alternative distribution of magnitude values. In this alternative embodiment, the alternative distribution of magnitude values is derived from the distribution of magnitude values 211 of the previous iteration. Specifically, processing block 258 subtracts the distribution of magnitude values of the input image 210 from the distribution of magnitude values 211 of the previous iteration, scales that difference by a gain factor a and subtracts the scaled difference from the input image 210. This is expressed mathematically by the following equations, wherein the subscript text and numbers indicate the iteration number:

Rₙ₊₁[x,y]=F′{exp(iΨₙ[u,v])}

Ψₙ[u,v]=∠F{η·exp(i∠Rₙ[x,y])}

η=T[x,y]−α(|Rₙ[x,y]|−T[x,y])

where:

F′ is the inverse Fourier transform;

F is the forward Fourier transform;

R[x, y] is the complex data set output by the third processing block 256;

T[x, y] is the input or target image;

∠ is the phase component;

ψ is the phase-only hologram 280B;

η is the new distribution of magnitude values 211B; and

α is the gain factor.

The gain factor α may be fixed or variable. In some embodiments, the gain factor α is determined based on the size and rate of the incoming target image data. In some embodiments, the gain factor α is dependent on the iteration number. In some embodiments, the gain factor α is solely function of the iteration number.

The embodiment of FIG. 2C is the same as that of FIG. 2A and FIG. 2B in all other respects. It may be said that the phase-only hologram ψ(u, v) comprises a phase distribution in the frequency or Fourier domain.

In some embodiments, the Fourier transform is performed using the spatial light modulator. Specifically, the hologram data is combined with second data providing optical power. That is, the data written to the spatial light modulation comprises hologram data representing the object and lens data representative of a lens. When displayed on a spatial light modulator and illuminated with light, the lens data emulates a physical lens—that is, it brings light to a focus in the same way as the corresponding physical optic. The lens data therefore provides optical, or focusing, power. In these embodiments, the physical Fourier transform lens 120 of FIG. 1 may be omitted. It is known in the field how to calculate data representative of a lens. The data representative of a lens may be referred to as a software lens. For example, a phase-only lens may be formed by calculating the phase delay caused by each point of the lens owing to its refractive index and spatially-variant optical path length. For example, the optical path length at the centre of a convex lens is greater than the optical path length at the edges of the lens. An amplitude-only lens may be formed by a Fresnel zone plate. It is also known in the art of computer-generated holography how to combine data representative of a lens with a hologram so that a Fourier transform of the hologram can be performed without the need for a physical Fourier lens. In some embodiments, lensing data is combined with the hologram by simple addition such as simple vector addition. In some embodiments, a physical lens is used in conjunction with a software lens to perform the Fourier transform. Alternatively, in other embodiments, the Fourier transform lens is omitted altogether such that the holographic reconstruction takes place in the far-field. In further embodiments, the hologram may be combined in the same way with grating data—that is, data arranged to perform the function of a grating such as beam steering. Again, it is known how to calculate such data. For example, a phase-only grating may be formed by modelling the phase delay caused by each point on the surface of a blazed grating. An amplitude-only grating may be simply superimposed with an amplitude-only hologram to provide angular steering of the holographic reconstruction.

In some embodiments, the Fourier transform is performed jointly by a physical Fourier transform lens and a software lens. That is, some optical power which contributes to the Fourier transform is provided by a software lens and the rest of the optical power which contributes to the Fourier transform is provided by a physical optic or optics.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

Embodiments relate to Fourier holography and Gerchberg-Saxton type algorithms by way of example only. The present disclosure is equally applicable to Fresnel holography and Fresnel holograms which may be calculated by a similar method. The present disclosure is also applicable to holograms calculated by other techniques such as those based on point cloud methods.

### Light Modulation

A spatial light modulator may be used to display the light modulation (or diffractive) pattern including the computer-generated hologram. If the hologram is a phase-only hologram, a spatial light modulator which modulates phase is required. If the hologram is a fully-complex hologram, a spatial light modulator which modulates phase and amplitude may be used or a first spatial light modulator which modulates phase and a second spatial light modulator which modulates amplitude may be used.

In some embodiments, the light-modulating elements of the spatial light modulator are cells containing liquid crystal. That is, in some embodiments, the spatial light modulator is a liquid crystal device in which the optically-active component is the liquid crystal. Each liquid crystal cell is configured to selectively-provide a plurality of light modulation levels. That is, each liquid crystal cell is configured at any one time to operate at one light modulation level selected from a plurality of possible light modulation levels. Each liquid crystal cell is dynamically-reconfigurable to a different light modulation level from the plurality of light modulation levels. In some embodiments, the spatial light modulator is a reflective liquid crystal on silicon (LCOS) spatial light modulator but the present disclosure is not restricted to this type of spatial light modulator.

A LCOS device provides a dense array of pixels within a small aperture (e.g. a few centimetres in width). The pixels are typically approximately 10 microns or less which results in a diffraction angle of a few degrees meaning that the optical system can be compact. It is easier to adequately illuminate the small aperture of a LCOS SLM than it is the larger aperture of other liquid crystal devices. An LCOS device is typically reflective which means that the circuitry which drives the pixels of a LCOS SLM can be buried under the reflective surface. The results in a higher aperture ratio. In other words, the pixels are closely packed meaning there is very little dead space between the pixels. This is advantageous because it reduces the optical noise in the replay field. A LCOS SLM uses a silicon backplane which has the advantage that the pixels are optically flat. This is particularly important for a phase modulating device.

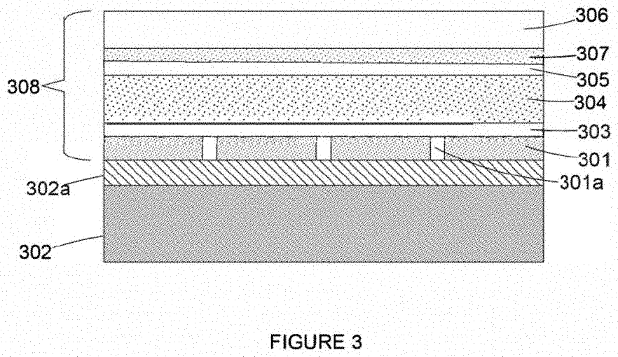

A suitable LCOS SLM is described below, by way of example only, with reference to FIG. 3. An LCOS device is formed using a single crystal silicon substrate 302. It has a 2D array of square planar aluminium electrodes 301, spaced apart by a gap 301a, arranged on the upper surface of the substrate. Each of the electrodes 301 can be addressed via circuitry 302a buried in the substrate 302. Each of the electrodes forms a respective planar mirror. An alignment layer 303 is disposed on the array of electrodes, and a liquid crystal layer 304 is disposed on the alignment layer 303. A second alignment layer 305 is disposed on the planar transparent layer 306, e.g. of glass. A single transparent electrode 307 e.g. of ITO is disposed between the transparent layer 306 and the second alignment layer 305.

Each of the square electrodes 301 defines, together with the overlying region of the transparent electrode 307 and the intervening liquid crystal material, a controllable phase-modulating element 308, often referred to as a pixel. The effective pixel area, or fill factor, is the percentage of the total pixel which is optically active, taking into account the space between pixels 301a. By control of the voltage applied to each electrode 301 with respect to the transparent electrode 307, the properties of the liquid crystal material of the respective phase modulating element may be varied, thereby to provide a variable delay to light incident thereon. The effect is to provide phase-only modulation to the wavefront, i.e. no amplitude effect occurs.

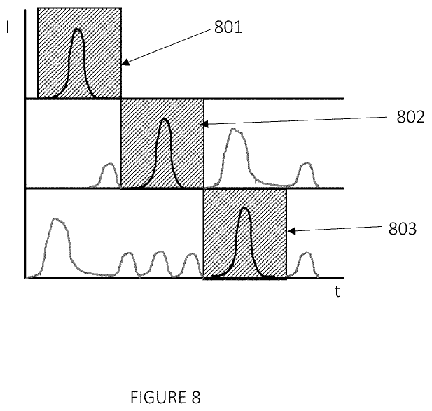

The described LCOS SLM outputs spatially modulated light in reflection. Reflective LCOS SLMs have the advantage that the signal lines, gate lines and transistors are below the mirrored surface, which results in high fill factors (typically greater than 90%) and high resolutions. Another advantage of using a reflective LCOS spatial light modulator is that the liquid crystal layer can be half the thickness than would be necessary if a transmissive device were used. This greatly improves the switching speed of the liquid crystal (a key advantage for the projection of dynamic light patterns). However, the teachings of the present disclosure may equally be implemented using a transmissive LCOS SLM. In embodiments, the received computer-generated hologram is an input hologram to a tiling engine. The input hologram is “tiled” on the spatial light modulator in accordance with a tiling scheme and the tiling scheme is dynamically changed, for example, it is changed between input holograms. The concepts of a “tile” and “tiling” are further explained with reference to FIG. 8.

### Light Detection and Ranging Using an Array of Time of Flight Measurements

The light detection and ranging, “LiDAR”, system of the present disclosure is arranged to make time of flight measurements of a scene. The LiDAR system comprises a holographic projector comprising: a spatial light modulator arranged to display light modulation patterns, each light modulation pattern comprising a hologram and, optionally, a grating function having a periodicity; a light source arranged to illuminate each displayed light modulation pattern in turn; and a projection lens arranged to receive spatially modulated light from the spatial light modulator and project a structured light pattern corresponding to each hologram onto a respective replay plane. The position of the structured light pattern on the replay plane may be determined by the periodicity of the optional grating function. The LiDAR system further comprises a detector comprising an array of detection elements and an imaging lens arranged such that each detection element receives light from a respective sub-area of the holographic replay plane, wherein the sub-areas collectively define a field of view of the detector on the replay plane.

The field of view of the detector may be continuous. That is; the individual fields of view of the light detecting elements comprised within the detector may form a continuous area. That is; there may be no gaps between adjacent individual fields of view (IFOV's) of the respective light detecting elements.

The light source may be a laser light source. The light may be, for example, infra-red (IR) light, visible light or ultra-violet light.

The system controller may be configured to provide an output to the detector. For example, it may provide an output indicating the timing and/or duration of light pulses, from the light source.

The grating function (also known as a phase-ramp function or a software grating) may be added to the hologram in order to provide a linear displacement of the light pattern on the (holographic) replay plane. The period of the grating function may determine the magnitude of the displacement. A repository of different grating functions may be provided, and a feedback system may be incorporated to select the required grating function from the repository of different grating functions, based on a control signal.

The system may be arranged to ‘observe or ‘interrogate’ a plane or plurality of places in space, within a scene. The distance of the plane, from the holographic projector and the detector, may be variable. The system may be arranged to continually probe a scene. It may be said that the system provides a temporal sequence of light detection and ranging ‘frames’ (or display events). Each frame may comprise a display event (or ‘an illumination event’) and a detection event. Each frame has a corresponding range that defines the location of the plane in the scene that will be interrogated. The plane that will be interrogated may be substantially parallel to a plane of the source and detector. The range is a perpendicular distance between those two planes, in such an arrangement.

The structured light pattern comprises a plurality of discrete light features, wherein each discrete light feature is formed within a respective sub-area of the sub-areas that collectively define the field of view of the detector. The structured light pattern may have a non-uniform brightness across its area within the replay field. The discrete light features (also called “light spots” herein) may be separated by dark areas, and/or may be a pattern of light of graded brightness or intensity. The structured light may be characterised by its form, shape and/or pattern.

The light detection and ranging system may be used to form a temporal sequence of varying structured light patterns within a scene. The sequence may be derived from a pre-determined sequence, or it may be a random sequence, or it may be a sequence arising from selections and determinations made by the controller, based on signals or other information received during, or as a result of, previous operation of the system.

The system may be configured such that a plurality of different points (on the same plane or within a depth of focus provided by the projection lens) in the scene may be interrogated at the same time. This may be achieved by illuminating the scene with structured light (e.g. a periodic array of discrete light spots) and using an array of detection elements combined with an imaging lens such that there is correlation between discrete light spots and individual detection elements. The person skilled in the art of optics will understand how the imaging lens may be chosen based on the desired detection resolution within the scene and so a detailed description of the design of the imaging lens is not required below.

The system may be arranged to make a time of flight measurement in relation to each discrete light feature of a structured light pattern based on a detection signal from the corresponding detection element in order to form a plurality of time of flight measurements in relation to the structured light pattern. The time of flight may comprise a time that the light has taken to travel from the holographic projector, for example from the spatial light modulator, to the scene and back to the detector.

The light modulation pattern may comprise a lensing function having a focal length, wherein the distance from the spatial light modulator to the replay plane is determined by the focal length. The holographic projector, or a controller associated therewith, may be arranged to determine the focal length of the lensing function that is required to focus the structured light pattern on a replay plane of interest, based on the control signal. In some circumstances, a lensing function will not be needed in order to focus the structured light pattern correctly on a replay plane of interest.

The system controller may be arranged to determine a subsequent structured light pattern of a sequence of structured light patterns based on detection signals received from the array of detection elements. For example, the detection signals may give an indication of the distance of an object, or of a part of an object, or of the lack of an object, at a particular distance and the controller may use that information to select and control the structured light pattern that will be used next (or subsequently) to illuminate the scene.

The distance information may define the location of the replay plane in the scene for a subsequent structured light pattern. The distance information may, in other words, be the distance between the spatial light modulator and the replay plane, for that subsequent structured light pattern.

The spatial light modulator and the array of detection elements may be substantially parallel to one another and spatially separated. That is; they may occupy a common plane.

The projection lens and the imaging lens may be substantially parallel to each other. That is; they may occupy a common plane.

The projection lens and imaging lens may be substantially parallel to the spatial light modulator and array of detection elements. The distance between the spatial light modulator and the replay plane (which may be referred to as the ‘range’ of the system) may thus be a substantially perpendicular distance.

The distance information may define a plane in the scene. The scene may comprise, or be comprised within, a detected object.

### Recursive Light Detection and Ranging Using Structured Light

In overview, the present disclosure relates to LiDAR illumination using a recursive approach to map the scene, building up point cloud data more quickly, or requiring emission of less light, than in a conventional LiDAR configuration. Illumination of the scene is set by adjusting a hologram.

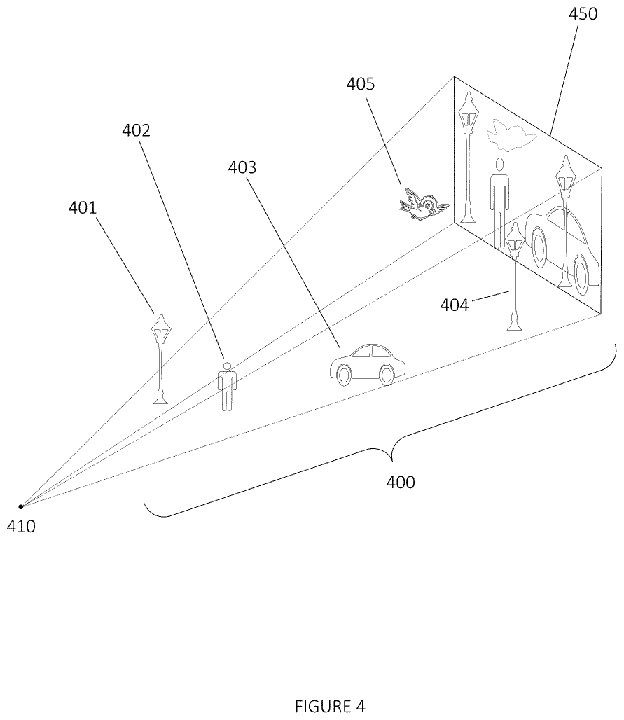

FIG. 4 shows how a LIDAR system may build-up a map 450 representative of a 3D scene 400 comprising a first object 401 nearest the LIDAR device 410, a second object 402, a third object 403, a fourth object 404 and a fifth object 405 most distant from the LIDAR device 410. In this example, the first object 401 is a first lamppost, the second object 402 is a person, the third object 403 is a car, the fourth object 404 is a second lamppost and the fifth object 405 is a bird. Each object is present in the map 405 of the 3D scene 400. At least one time-of-fight measurement is associated with each object.

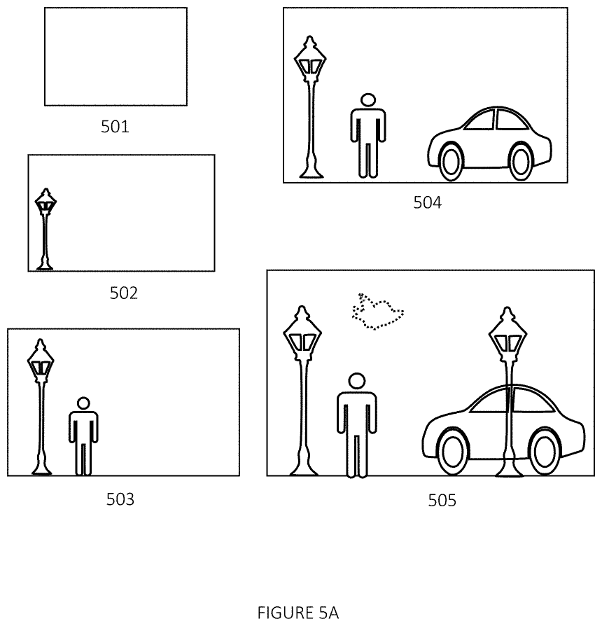

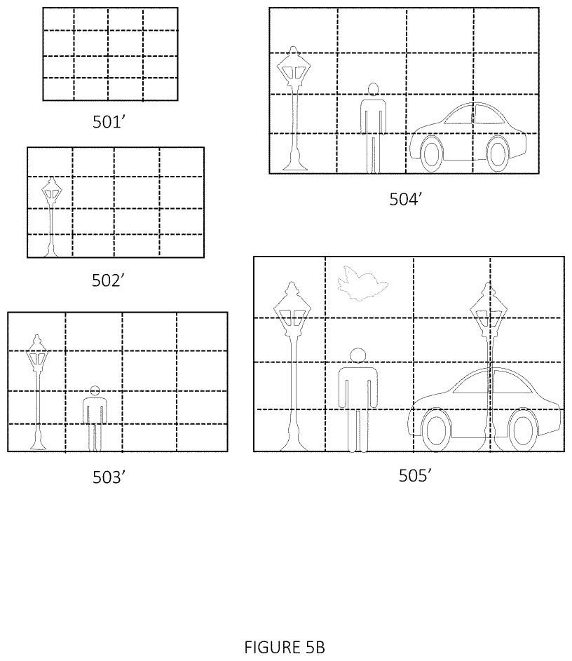

FIGS. 5A and 5B show how the map 450 representative of the 3D scene 400 may be built up depth plane by depth plane in accordance with the present disclosure.

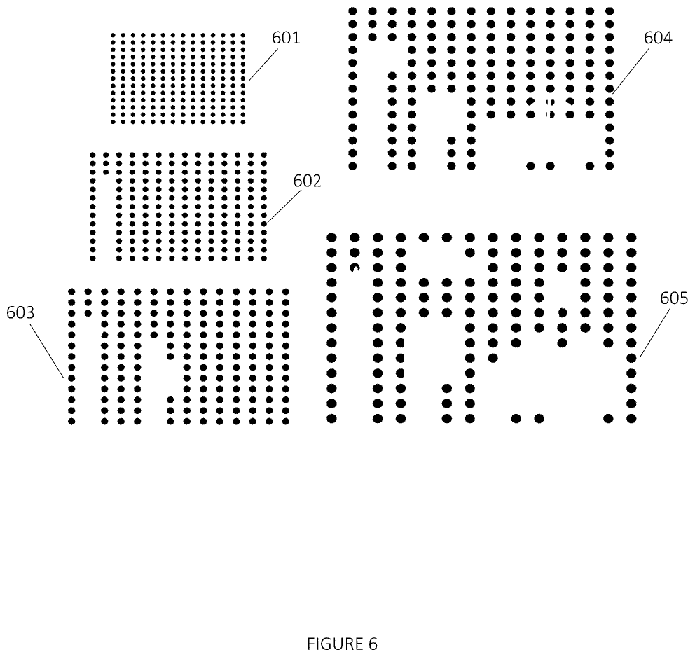

In a first step of this example, the scene is fully illuminated using a light pattern 501 having uniform brightness. It is not, however, essential that the brightness is uniform in this first step. The relevant point is that the light is effectively “on” everywhere in the scan area. The light pattern may be a regular array of light spots, as described below with reference to FIG. 6. The light spots may have substantially uniform brightness or a subset of the light spots may have substantially uniform brightness. Further optionally, illumination in accordance with each light pattern may occur at a single time (as shown in FIG. 5A) or may be built up from a series of sub-regions illuminated in sequence (e.g. as shown in FIG. 5B). The blocks of each light pattern may be projected onto the scene one at a time. The intensity of light returned to the LiDAR detector depends on the range and reflectivity of the object in the scene. Light scattered from objects which are close to the LiDAR (e.g. the first lamppost) is relatively easily detected so the LiDAR system can identify a point cloud point relatively quickly (e.g. after a small number of laser pulses and/or small number of detector exposures). Light scattered from objects which are far from the LiDAR is less easily detected. A point cloud point (i.e. z distance for a trajectory θx, θy) is generated when a confidence criterion (e.g. signal to noise ratio) is met for light detected from an object. For the uniform illumination of light pattern 501, a confidence criterion for a point cloud point is satisfied for near/reflective objects before it is satisfied for distant/non-reflective objects. Once a confidence criterion is satisfied for a point cloud point, it is no longer necessary to illuminate that trajectory (θx, θy) until the next point cloud refresh.

In a second step, the scene is illuminated with a second light pattern 502 comprising substantially uniform illumination (or uniform array of light spots) but with some dark (non-illuminated) regions, shown in outline by black lines in FIG. 5A, for trajectories where point cloud points which have already satisfied a confidence criterion are located. In this case, the region (more specifically, the trajectories) corresponding to the first lamppost is removed from the first light pattern 501 in order to form the second light pattern 502. Typically, these dark regions will correspond to objects which are close to the detector or which have a high reflectivity. The overall optical power is therefore concentrated into regions of the scene where more data is required. This is good for power efficiency. Additionally, processing of data from the detector can focus attention only on regions where the point cloud points still need to be generated, saving computation time.

The method comprises any number of light patterns (illumination events) as required in a recursive manner (e.g. light patterns 503, 504 and 505 in FIGS. 5A and 5B), where the light regions of the next light pattern are the regions of the scene where the point cloud has not yet been generated meeting a confidence criterion. Each light pattern is formed by illuminating a respective hologram displayed on a spatial light modulator. In some embodiments, each hologram after the first hologram (corresponding to the first illumination frame—which comprises substantially uniform illumination of the scene) is calculated from the point cloud data obtained thus far in accordance with methods described herein.

In some embodiments, the generally continuous/uniform illumination shown in FIGS. 5A and 5B is in fact an array of light spots or dots. FIG. 6 shows an embodiment in which the recursive scheme in accordance with this disclosure using a plurality of light spots. Light patterns 601 to 605 of FIG. 6 correspond to light patterns 501 to 505 of FIG. 5A. The reader will understand there will be a trade-off between the resolution (dot density) of the light pattern and the average optical power of each dot, given that depending on the resolution of the hologram, the optical power will need to be distributed accordingly.

The recursive Holographic LiDAR approach disclosed herein excludes, from the next scan, objects (more specifically, trajectories) that have already returned a sufficient number of photons. Because each light pattern (illumination event) is formed from a hologram, this allows more optical power to be delivered in the regions of the scene which still need more data. Overall the point cloud can be assembled with all points meeting the confidence criteria more quickly, or with less total light emission, than if the entire scene is illuminated continuously. This concept exploits the powerful illumination control of holographic LiDAR.

### Detector Gating in a Recursive Scheme

The inventors have identified a further improvement to the recursive LIDAR scheme comprising modulation of the repetition frequency and optionally light source power used to form the light patterns. In some embodiments, the repetition rate of the light used to illuminate the hologram is different for each plane of the set of planes used to build up the map of the scene. In some embodiments, the first plane is formed using a first repetition rate, the second plane is formed using a second repetition rate and so on. In some embodiments, each successive plane of the recursive scan is further away from the LIDAR device than the preceding plane and the repetition rate decreases with each successive plane. The first plane may be the plane closest to the LIDAR device. In other examples, the repetition rate increases with distance from the LIDAR device. More optical energy is directed to the bright areas of the scene with each successive plane because a hologram of an image, not an image, is used to form each light pattern. In embodiments, the peak optical power in the bright areas increases as the repetition rate decreases.

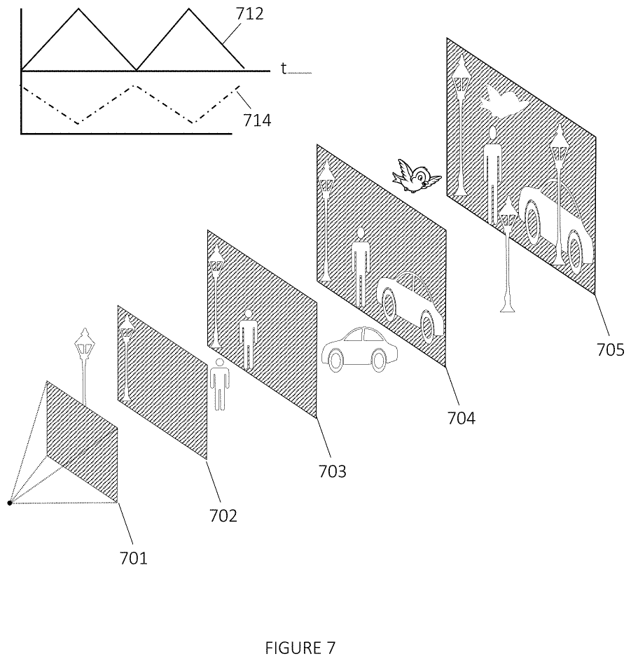

FIG. 7 illustrates the basic principle of operation. Firstly, a first (uniform) light pattern 701 is holographically projected onto the scene as pulsed light with a relatively low peak power of each pulse (beginning of the rising part of the peak output power 712) and with a repetition frequency that corresponds to a first distance which is close to the LiDAR device (i.e. high frequency, beginning of the falling part of repetition frequency 714). That is, the repetition frequency is high such that the time interval between the pulses of the light is similar to the time-of-flight for photons to propagate from the LiDAR device to a point which is a first distance from the LiDAR device and then propagate back to the LiDAR device. The returned photons from the first object that the first light pattern has illuminated (in this case, the first lamp post) are registered by the array detector and the time-of-flight for these photons is measured such that it exceeds a first threshold value. The light source may be configured such that the range of detection corresponds to the first distance. That is, the peak power of the pulses in the first light pattern is lower than a peak power which would result in substantial detection of photons (exceeding the threshold value) for reflection from points further away from the LiDAR system than the first distance. In another example, detection of ranges not substantially higher than the first distance may be provided by discarding data where the measured number of photons at the detector is so low that it is unlikely to have been due to reflection from a point at up to the first distance from the LiDAR system. Subsequently, a second light pattern 702 which is a generally uniform light pattern but without illumination in any area that corresponds to the trajectories where the first threshold value was exceeded. In this manner, optical power is distributed to the remaining scene, providing power efficiency and saving computation time of the point cloud generation because it is not necessary to compute point cloud points corresponding to the trajectories which are not illuminated.

For the second light pattern (using a second hologram), the peak power of each pulse may be increased so that the range of detection is increased. The peak power of each pulse, or more generally the optical energy of each pulse, may be increased in a linear manner with the range of detection. In another example, if the range of detection is increased from a first range d1 to a second range d2, the peak power of each pulse, or more generally the optical energy of each pulse, may be increased by a ratio of (d2/d1)², thereby providing that similar rate of photons may be detected for reflection by a given object at the second range as for the same object at the first range, allowing for inverse square dependence on distance for the returned photons. In yet another example the optical energy of each pulse may be increased by a ratio of up to (d2/d1)⁴, thereby providing similar rate of photons may be detected, allowing additionally for an inverse square spreading of the area of the illumination spot with distance. The repetition frequency is decreased to correspond to a second distance which is larger than the first distance, in order to be able to measure the longer range without so-called “wrap-around” in which the correct correlation between transmitted pulses and reflected pulses because successive pulses are too close together. The second hologram leads to detection of photons reflected from a second object (a human figure in this example), which are registered by the array detector and exceed a second threshold value. The second threshold value may be set to be lower than the first threshold value because reflection from a larger distance may result in fewer photons reaching the detector. The third hologram will form a third light pattern 703 that is generally uniform again but excluding the trajectories where the threshold values were exceeded for the first and second light patterns. Peak power may again be increased and repetition frequency is again decreased. The process comprises generating as many holograms (and corresponding light patterns—e.g fourth light pattern 704 and fifth light pattern 705) as required in a recursive manner, wherein the illumination distribution of the next light pattern is determined by the trajectories for which returned photons exceeded threshold values by the previous one/s. In the embodiment of FIG. 7, the fifth light pattern 705, from the final hologram, comprises light only on trajectories that have not yielded photon returns exceeding threshold values within the volume of space covered by the previous four light patterns. In FIG. 7, planes 701 to 705 are 1 metre apart. The fifth light pattern, for example, therefore comprises light only on trajectories that do not contain an object within 4 metres of the LIDAR device. It will be understood that each light pattern relates to respective volume of the scene. In embodiments, these volumes do not overlap and each volume is therefore unique. In embodiments, the volumes are continuous in depth space. For example, the third light pattern 703 relates to trajectories to points that are more than 2 metres from the LIDAR device but less than 3 metres from the LIDAR device and the fourth light pattern 704 relates to trajectories to points that are more than 3 metres from the LIDAR device but less than 4 metres from the LIDAR device.

Again, FIG. 5A, illustrates the five different light patterns described in FIG. 7, which will be holographically projected by the LIDAR system. The black lines outlining objects delimit areas of the light pattern where light is not present. In some embodiments, the uniform light pattern is, in fact, an array of laser points (dots) creating a high-resolution system in which light spots are omitted in each successive light pattern for trajectories to points from which a valid return signal has already been detected.

Advantageously, because the repetition frequency of the pulses in the light pattern is changed with each plane, photons coming from background sources (e.g. from sunlight or from other LiDAR devices) can be rejected, as can be understood from the following. The reader will understand that light pulses that repeat at a relatively high repetition frequency (i.e. small time interval between pulses) are suitable for small z-axis (depth) distances. Starting from a reference repetition frequency for the first light pattern (e.g x MHz), the system can detect photons that have travelled up to a distance with a time-of-flight of 1/x μs (which corresponds to a fixed number of counts in the detector's time-to-digital-converter, “TDC”). This distance corresponds to the propagation distance from the LiDAR device to a reflecting object and back to the LiDAR device, i.e. to double the distance between the reflecting object and the LiDAR device. In the second light pattern, where the repetition frequency has been decreased to e.g. x−Δx MHz, the system can detect photons that have travelled up to a distance with a time-of-flight of 1/(x−Δx) μs (again, this is a fixed number in the TDC). However, because the scene has already been illuminated with the first light pattern at the first repetition frequency, the inventors have recognised that for the second light pattern it is only necessary to consider time-of-flight data falling between the maximum photon travel time of the first light pattern and the maximum photon travel time of the second light patter. Photons with other time-of-flight for the second light pattern can be discarded as noise—e.g. interference from other LiDAR systems, which in practice could generate “false” data points. This approach is referred to herein as detector gating or range gating.

An embodiment comprises triangular—and, optionally, synchronised-modulation of the light source power and repetition frequency, as shown in FIG. 7.

FIG. 8 illustrates detector gating in accordance with this disclosure. The x-axis of FIG. 8 is time-of-flight and the y-axis is number of photon counts. Detector, or range-gating is, based on the recursive relationship between the different repetition frequencies. The resolution of the repetition frequency changes define how narrow the window of interest is for the point cloud data, making the interference rejection more or less efficient. FIG. 8 shows a first time-gate 801 in accordance with a first scan (e.g. first light pattern 701 of FIG. 7). Photons outside of the first time-gate 801 are discarded by the first scan. FIG. 8 shows a second time-gate 802 for a second scan after the first scan (e.g. second light pattern 702 of FIG. 7). Photons outside of the second time-gate 802 are discarded by the second scan. FIG. 8 shows a third time-gate 803 for a third scan after the second scan (e.g. third light pattern 703 of FIG. 7). Photons outside of the third time-gate 802 are discarded by the third scan. Range-gating therefore reduces the contribution of background light to the point cloud obtained using the recursive method of the present disclosure.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A method of light detection and ranging, the method comprising:
illuminating a scene with a first light pattern and monitoring for first light return from the scene with an array of detection elements;
obtaining first point cloud data from first parts of the scene where the light return exceeds a first threshold value;
determining a second light pattern by reducing an intensity of the first light pattern in areas wherein first point cloud data was obtained; and
illuminating the scene with the second light pattern and monitoring for second light return from the scene with the array of detection elements.

2. The method of claim 1, further comprising obtaining second point cloud data from second parts of the scene where the second light return exceeds a second threshold value.

3. The method of claim 2, further comprising:
determining an nth light pattern by reducing the intensity of the (nth−1) light pattern in the areas wherein (nth−1) point cloud data was obtained; and
illuminating the scene with the nth light pattern and monitoring for nth light return from the scene with the array of detection elements.

4. The method of claim 2, wherein each point cloud obtained by the array of detection elements corresponds to a different depth volume in the scene, wherein a distance from the array of detection elements to the depth volume in the scene increases with each successive light pattern.

5. The method of claim 1, further comprising at least maintaining a total intensity of the light pattern with each successive light pattern.

6. The method of claim 1, wherein each light pattern is formed by illuminating a hologram corresponding to the respective light pattern.

7. The method of claim 1, wherein determining each light pattern is followed by the step of calculating of a hologram of the light pattern.

8. The method of claim 1, wherein the first light pattern comprises a regular array of light spots.

9. The method of claim 1, wherein the light used to illuminate the scene is pulsed and the method further comprises changing a pulse repetition rate at least once such as reducing the pulse repetition rate with each successive light patten.

10. The method of claim 9, further comprising gating a detection window of the array of detection elements and increasing a time delay between illumination and a start of each gate with each successive light pattern.

11. A light detection and ranging system comprising:
a projector arranged to illuminate a scene with a first light pattern and then a second light pattern; and
an array of detection elements arranged to monitor for light return in association with the first light pattern and light return in association with the second light pattern; and
a controller arranged to obtain first point cloud data from first parts of the scene where first light return corresponding to a first light pattern exceeds a first threshold value and determine the second light pattern by reducing an intensity of the first light pattern in areas wherein first point cloud data was obtained.

12. The light detection and ranging system of claim 11, wherein the projector is a holographic projector comprising a spatial light modulator arranged to display a first hologram of the first light pattern and then a second hologram of the second light pattern.

13. The light detection and ranging system of claim 11, wherein the first light pattern comprises a regular array of light spots, and wherein the second light pattern comprises a subset of the light spots of the regular array of light spots of the first light pattern.

14. The light detection and ranging system of claim 11, wherein the first light pattern is formed using light having a first pulse repetition rate and the second light pattern is formed using light having a second pulse repetition rate, wherein the second pulse repetition rate is less than the first pulse repetition rate.

15. The light detection and ranging system of claim 11, wherein the array of detection elements has a detection window and the controller is arranged to increase a time between illumination and start of each detection window with each successive light pattern.

16. Tangible, non-transitory computer-readable media comprising instructions stored therein, wherein the instructions, when executed by one or more processors, cause a computing device to perform functions comprising:
controlling a projector to illuminate a scene with a first light pattern followed by illuminating the scene with a second light pattern; and
controlling an array of detection elements to monitor for light return in association with the first light pattern and light return in association with the second light pattern;
obtaining first point cloud data from first parts of the scene where first light return corresponding to a first light pattern exceeds a first threshold value; and
based on the first point cloud data, determining the second light pattern by reducing an intensity of the first light pattern in areas wherein first point cloud data was obtained.

17. The tangible, non-transitory computer-readable media of claim 16, wherein the functions further comprise:
obtaining second point cloud data from second parts of the scene where the second light return exceeds a second threshold value.

18. The tangible, non-transitory computer-readable media of claim 17, wherein the functions further comprise:
determining an nth light pattern by reducing the intensity of the (nth−1) light pattern in the areas wherein (nth−1) point cloud data was obtained; and
illuminating the scene with the nth light pattern and monitoring for nth light return from the scene with the array of detection elements.

19. The tangible, non-transitory computer-readable media of claim 16, wherein the projector is a holographic projector comprising a spatial light modulator arranged to display a first hologram of the first light pattern and then a second hologram of the second light pattern.

20. The tangible, non-transitory computer-readable media of claim 16, wherein controlling the projector to illuminate the scene with the first light pattern followed by illuminating the scene with the second light pattern comprises:
controlling the projector to form the first light pattern by using light having a first pulse repetition rate;
controlling the projector to form the second light pattern by using light having a second pulse repetition rate, wherein the second pulse repetition rate is less than the first pulse repetition rate.
